(19) United States
(12) Patent Application Publication
(10) Pub. No.: US 2002/0026396 A1
(43) Pub. Date: Feb. 28, 2002

(54) System and method facilitating personal electronic financial transactions

(76) Inventors: Warren T. Dent, Redmond, WA (US); Bassam Saliba, Issaquah, WA (US); Kyle S. Young, Sammamish, WA (US); Michael Waterston, Seattle, WA (US)

Correspondence Address: LEE & HAYES PLLC, 421 W RIVERSIDE AVENUE SUITE 500, SPOKANE, WA, 99201

(21) Appl. No.: 09/751,437

(22) Filed: Dec. 29, 2000

Related U.S. Application Data
(63) Continuation of application No. 09/553,965, filed on Apr. 21, 2000.

(51) Int. Cl. G06F 17/60

(52) U.S. Cl. 705/35

(57) ABSTRACT

A data network comprising a plurality of computing devices and an innovative data server. The computing devices facilitate access to the network by a plurality of participants. The data server, coupled to the data network and responsive to the plurality of computing devices, includes a memory device to store at least one financial account for each of the plurality of participants, and an innovative financial transaction manager incorporating the teachings of the present invention. The financial transaction manager is selectively invoked by participants to manage access to and manipulation of financial account assets to effect requested financial transactions with any network participant or non-participant.

### RELATED APPLICATIONS

This application is a continuation of a application Ser. No. 09/553,965 entitled “A System and Method for Facilitating Personal Electronic Financial Transactions”, filed Apr. 21, 2000, by Dent et al. (now abandoned).

### TECHNICAL FIELD

This invention generally relates to data networks and, more particularly, to a system and associated methods for facilitating personal electronic financial transactions.

### BACKGROUND OF THE INVENTION

The concept of buying goods on “credit”, or a promise for future payment, is not new. Today, nearly everyone in the industrial world is familiar with receiving bills for goods and services. Every month, like clockwork, millions of consumers receive bills for goods and services. For convenience, the term “consumer” is used throughout this document to represent both a typical person who consumes goods and services as well as a business that consumes goods and services.

At the end of each billing cycle, a biller generates a bill or statement for each consumer account having a positive or negative account balance, or having transactions that yielded a zero balance. As used herein, a “biller” is any party that originates billing statements for goods or services rendered to the consumer. Examples of billers are utilities, government, merchants, and intermediate billing services such as banks. The billing statement is typically customized according to the biller's preferences. For example, it is common for billing statements to be printed on colored paper, display the biller's logo, provide a billing summary, and show itemized transactions. This information is organized in a custom format that is unique to and controlled by the biller.

The biller also creates remittance information that associates the consumer account with the bill and any payment toward the bill. The remittance information is typically in the form of a detachable stub or coupon that the consumer detaches from the billing statement and returns along with the payment. This remittance stub is also customized according to the biller's preferences.

Recently, electronic bill presentment and payment (EBPP) systems have been developed to automate this process of bill delivery and payment. Companies such as Microsoft, Checkfree and Visa, Inc. are developing products in this space, the result of which heretofore has been an associated number of proprietary, closed EBPP systems. One such system is described in U.S. Pat. No. 5,465,206, entitled “Electronic Bill Pay System,” which issued Nov. 7, 1995 and is assigned to Visa International. The Visa bill payment system permits bills to be sent by billers to consumers via U.S. mail or electronically via email. Unfortunately, the Visa system suffers from a number of drawbacks. First, the email message containing the bill must conform to requirements imposed by Visa. This requirement stems from the need to route remittance information back to the biller through the VisaNet® network (one of the four Automated Clearing Houses (ACH) used by financial institutions to clear transactions between accounts). Thus, the biller has little or no control over the format concerning how the bill is presented to the customer, but must instead accommodate a format compatible with this network. Second, the Visa system is designed to support the presentment of “bills” from corporate billers, and would not accommodate the myriad of financial transactions conducted among and between consumers. Third, these prior art EBPP systems (e.g., Visa, Checkfree, etc.) have not be designed for interoperability. Currently, there is no solution available to integrate all of the users from these disparate EBPP systems into a common, ubiquitous network.

These limitations are significant in a number of respects, the most notable of which are the cost and responsiveness of such prior art electronic financial systems. The technical limitations of presenting a bill through the Visa network, for example, effectively requires the biller to have a technical staff that is competent to structure the bills in the required format. The cost of supporting such a staff is prohibitively expensive to all but large corporations.

From a practical standpoint, the technical limitations associated with preparing bills for presentment and payment via the Visa system requires a monthly batch billing cycle. However, many of today's fastest-growing business opportunities that would greatly benefit from such an electronic financial network want to process financial requests instantaneously, or nearly so. The electronic commerce (eCommerce) marketplace presents a fine example. Today, eCommerce relies heavily on the use of the established credit card clearing house system, the cash-on-delivery (COD) service of carrier services, or an escrow service—all of which represent expensive solutions to the technical limitations of the Visa system. Auction houses, for example, typically utilize an escrow service to handle the commercial transaction between two individuals, protecting each of the buyer and the seller from the fraud of the other.

In addition, as alluded to above, the prior art electronic financial networks only support bill presentment and payment financial transactions. It will be appreciated, however, that payment of bills is only one of a number of different financial transactions performed each day by millions of consumers. Today, if a person wants to send money quickly to another (i.e., person to person financial transaction) they must either arrange for a wire transfer through their bank, or use third-party services such as, for example, “Western Union”. Depending on the amount of money involved in such a transaction, the use of wire or escrow services can be very expensive. Thus, the use of such prior art commercial systems are inconvenient, expensive and time consuming—yet they are extraordinarily profitable because suitable alternatives do not exist.

Thus, a truly ubiquitous financial network is required that enables all members of society to participate in electronic financial management, without the technical and cost limitations commonly associated with the prior art.

### SUMMARY OF THE INVENTION

This invention concerns a system and associated methods for facilitating personal electronic financial transactions. More specifically, the present invention concerns a data network comprising a plurality of computing devices and an innovative data server. The computing devices facilitate access to the network by a plurality of participants. The data server, coupled to the data network and responsive to the plurality of computing devices, includes a memory device to store at least one financial account for each of the plurality of participants, and an innovative financial transaction manager incorporating the teachings of the present invention. The financial transaction manager is selectively invoked by participants to manage access to and manipulation of financial account assets to effect requested financial transactions with any network participant or non-participant.

Financial transactions between network participants may be performed entirely electronically by moving assets between the financial accounts of the respective participants. Financial transactions initiated by in network participant to a non-participant may be performed electronically or manually. It will be appreciated that the ability to execute financial transactions with network participants and non-participants alike give rise to a number of innovative applications and business methods. For example, according to one innovative business method, financial transactions conducted with a non-participant include a solicitation to become a network participant. Indeed, such solicitations may include a further financial incentive to become a network participant. Thus, it will be appreciated that the financial transaction manager enables a network participant to electronically control and conduct financial transactions with anyone, regardless of whether they are a network participant or not. In this regard, the innovative financial transaction manager facilitates a truly ubiquitous financial data network.

According to one implementation of the present invention, the use of the financial transaction manager by a network participant does not require any special features or applications of the computing device. Accordingly, network participants may use a host of alternative computing devices to access the financial transaction manager via the data network. Personal computers, telephony devices, set-top boxes, personal digital assistants (PDAs), and electronic kiosks are just a few examples of suitable computing devices.

The financial account of a network participant controlled and maintained by the innovative financial transaction manager is linked to one or more traditional bank accounts such as, for example, a checking account, a savings account, a money market account, and/or a line of credit. In this regard, the financial transaction manager protects the security of the traditional bank account(s) by using the financial account as a “proxy” to the bank account(s). It will be apparent from the description to follow that a number of additional security measures may well be invoked by the financial transaction manager to ensure the security of the financial accounts and the integrity of the ubiquitous financial network.

### BRIEF DESCRIPTION OF THE DRAWINGS

The same reference numbers are used throughout the figures to reference like components and features.

FIG. 1 is a diagrammatic illustration of a data network incorporating the teachings of the present invention;

FIG. 2 is a block diagram of a computer system suitable for use as the financial service center of FIG. 1, according to one embodiment of the invention;

FIG. 3 is a block diagram of an example financial transaction manager, according to one embodiment of the present invention;

FIG. 4 is a block diagram of an example computing device suitable for use to access and utilize the financial service center of the data network;

FIG. 5 is a graphical illustration of an example account database maintained by the financial service center to facilitate financial transactions;

FIG. 6 is a graphical representation of an example data structure incorporating a transaction list, according to one aspect of the present invention;

FIG. 7 is a graphical illustration of an example user interface provided by the financial service center to enable users to conduct financial transactions;

FIG. 8 is a flow chart of an example method for registering with the financial service center;

FIG. 9 is a graphical representation of an example user interface provided by the financial service center to a user when registering with the financial service center;

FIG. 10 is a flow chart of an example method for initiating a financial transaction with another;

FIG. 11 is a graphical representation of an example user interface provided by the financial service center to initiate a financial transaction with another;

FIG. 12 is a graphical illustration of an example user interface provided by the financial service center when initiating a payment to one who is not registered with the financial service center;

FIG. 13 is a graphical representation of an example email notification sent from a user to a prospective payee by the financial service center;

FIG. 14 is a graphical illustration of an example check issued by the financial service center to a non-registered payee; and

FIG. 15 is a flow chart of an example method for requesting payment from another using the financial service center;

FIG. 16 is a graphical representation of an example user interface to enable a user to request payment from another;

FIG. 17 is a flow chart of an example method for authorizing payment using the financial service center to pay for goods/services provided by another;

FIG. 18 is a graphical illustration of an example user interface depicting the detail of a bill received in response to a purchase using the financial service center account;

FIG. 19 is a graphical illustration of an example user interface authorizing payment of a bill received in response to a purchase using the financial service center account;

FIG. 20 is a flow chart of an example method for quantifying a risk associated with honoring a requested financial transaction when insufficient funds are available to cover the financial transaction; and

FIG. 21 is a graphical representation of an alternate financial service center user interface using an email client.

### DETAILED DESCRIPTION

This invention concerns a system and method facilitating personal electronic financial transactions to anyone, including non-users of the system and methods. In this regard, the present invention overcomes a number of the limitations commonly associated with the prior art. Indeed, the present invention builds upon an innovative electronic bill presentment and payment system described in presently pending U.S. patent application Ser. No. 09/459,219, which is a continuation of U.S. patent application Ser. No. 08/734,518 (now U.S. Pat. No. 6,070,150), entitled Electronic Bill Presentment and Payment System, filed on Dec. 10, 1999 by Remmington, et al., the disclosure of which being expressly incorporated herein by reference. In describing the present invention, example network architectures and associated methods will be described with reference to the above drawings. It is noted, however, that modification to the architecture and methods described herein may well be made without deviating from the present invention. Indeed, such alternate embodiments are anticipated within the scope and spirit of the present invention.

Example System Architecture

Example Data Network

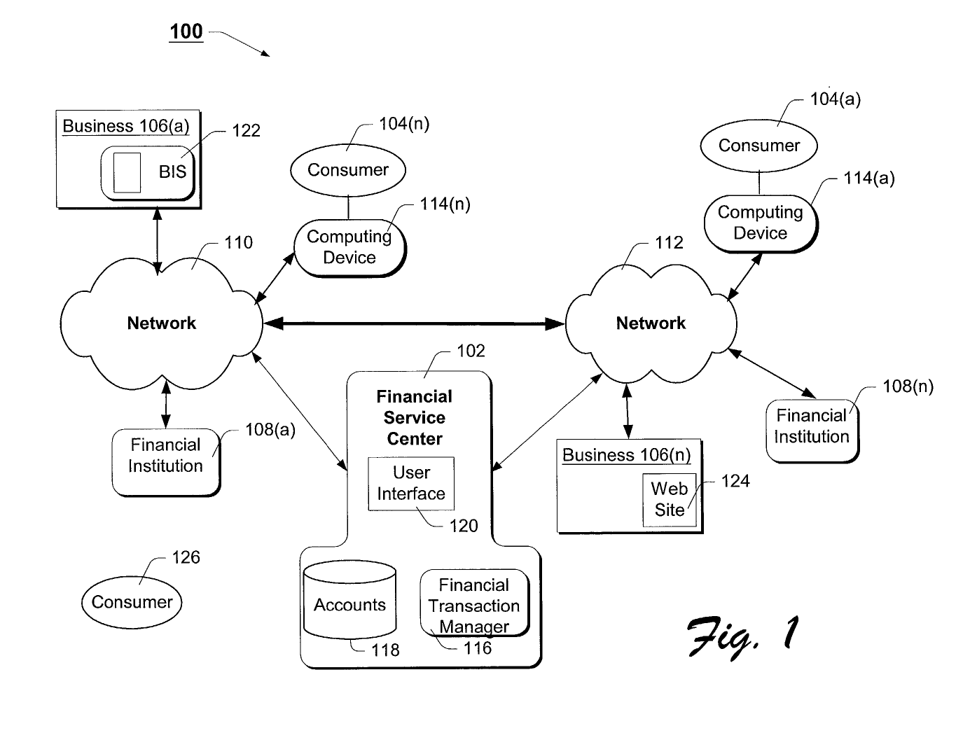

FIG. 1 illustrates an example network 100 including an innovative financial service center 102, which enables any user of the financial service center to conduct financial transactions with other users and non-users alike. Network 100 is comprised of a number of network participants (i.e., users registered with the financial service center) including consumers 104(a) . . . (n), businesses 106(a) . . . (n), and financial institutions 108(a) . . . (n) each communicatively coupled to the financial service center via one or more networks 110 and 112. As shown, networks 110 and 112 are intended to represent a wide variety of networks and a wide variety of communication technologies. In this regard, networks 110 and 112 may well comprise, for example, public networks (Internet), private networks (enterprise wide area networks (WAN), data networks and communication networks (public switched telephony network (PSTN), cellular telephony network, and the like). In this regard, financial network 100 is intended represent a composite of any number of networks through which participants can access and benefit from the innovative services provided by financial service center 102. Due to the confidential nature of the information and transactions, however, security measures are taken when communicating over public networks. According to one embodiment, for example, when the user is communicating with the FSC 102 via the Internet, FSC 102 employs the well known secure HyperText Transfer Protocol (HTTPS).

It will be appreciated that each of the network participants accesses and utilizes the resources of network 100 through a computing platform. Accordingly, consumers 104(a) . . . (n) are depicted communicative coupled to network 100 via computing devices 114(a) . . . (n), respectively. Similarly, businesses 106(a) . . . (n) and financial institutions 108(a) . . . (n) also access the resources of network 100 through one or more computing devices. For ease of illustration and explanation, the computing interface for businesses 106 and financial institutions 108 have been omitted from FIG. 1 so as to not obscure the innovative aspects of the present invention. For purposes of this discussion, use of the term “consumer”, “business”, “financial institution”, “user” or “network user” are each intended to represent the respective entity as well as their computing interface.

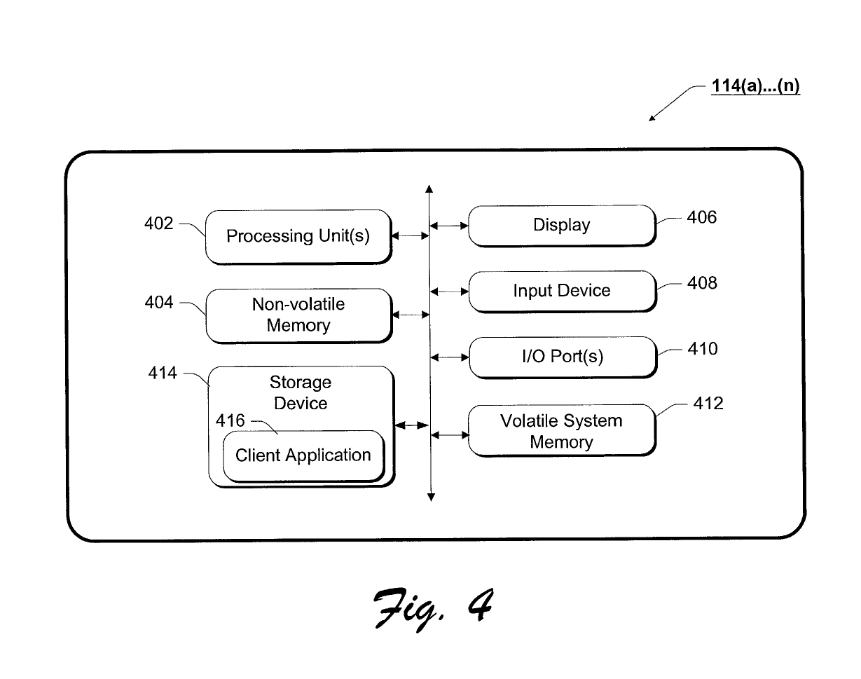

As used herein the computing devices used by network users are intended to represent a broad range of computing devices known in the art. As will be shown with reference to FIG. 4, a computing device, e.g., 114, does not require any special features or capability to access and interact with the financial service center 102 through a data or communication network 110 and 112 to utilize the features of the financial service center 102. Rather, the financial service center 102 selects an appropriate user interface 120 suitable for the accessing computing device 114. In this regard, the only requirement is that the computing device has user input/output (I/O) capability. Accordingly, computing devices 114(a) . . . (n) are intended to include, but are not limited to, personal computers, electronic kiosks, personal digital assistants (PDAs), wireless telephones, wireline telephones, thin-client terminals, and the like.

Financial service center (FSC) 102 is shown comprising a financial transaction manager (FTM) 116, a storage device 118 including financial service center accounts, and a user interface 120. According to one implementation, to be described more fully below, financial service center 102 is implemented using one or more computer systems, or data servers, which work in cooperation to provide the innovative services described herein. It will be appreciated, from the discussion to follow, that the innovative aspects of the financial service center 102 may well be embodied in hardware, e.g., analog or digital circuitry, or in software executed by one or more processor(s) of the computer system(s).

The financial transaction manager 116 provides the functional control of the services provided by financial service center 102. As will be described in more detail below, financial transaction manager 116 is responsive to commands received from a user via an instance of user interface 120. It will be appreciated, from the discussion to follow, that financial transaction manager 116 enables a user to initiate payments, request payments, authorize payments and perform a number of account maintenance and management functions. Unlike prior art systems, however, the financial transaction services of financial transaction manager 116 are not limited to corporate billers. Indeed, it will be appreciated that financial transaction manager 116 does not distinguish between “billers” and “consumers” in the EBPP sense of these terms. Rather, financial transaction manager 116 only distinguishes between “users” and “non-users” of the financial service center 102, as this distinction may control whether the transaction may be carried out entirely electronically. Thus, any user may, at a first time be a “biller” (i.e., request payment into a financial service center account), while at a second time be a “consumer” (i.e., purchase goods/services utilizing a financial service center account).

Moreover, unlike the EBPP systems of the prior art, the financial transaction manager 116 enables a user to initiate financial transactions with non-users 126 of the system, according to one aspect of the present invention. Indeed, according to certain business models to be described more fully below, financial transactions with non-users 126 may be tailored by the financial transaction manager 116 to include a special offer/invitation to establish an account on the financial service center 102 and “join” the service. In this regard, the financial transaction manager 116 enables the financial service center 102 to better accommodate the myriad of financial transactions performed daily by consumers, small business and large corporations alike—i.e., the financial transaction manager 116 facilitates the implementation of a truly ubiquitous financial network 100.

In addition to the financial transaction manager 116, financial service center 102 includes a storage medium of accounts 118. The storage medium of accounts 118 is responsive to instructions received from financial transaction manager 116. Although depicted in FIG. 1 as being a functional unit of financial service center 102, it will be appreciated that storage medium of accounts 118 may well be remotely located. Moreover, a plurality of such storage media of accounts 118 may well be required as the number of users of financial service center grows. According to one embodiment, a user establishes an account in storage device 118 to uniquely identify the user to the financial service center. The account may contain a plethora of personal information but, at a minimum, includes a unique user identifier (user_ID) and information regarding an asset-backed financial account at a financial institution (e.g., financial institution 108(a) . . . (n)). As used herein, the storage medium 118 is intended to represent a wide variety of storage media known in the art and, thus, need not be further described here.

As alluded to above, user interface 120 is intended to accommodate any of a number of different computing devices which may access and utilize the features of financial service center 102. In this regard, user interface 120 is intended to represent any of a number of audio and/or visual user interfaces commonly known in the art. In one embodiment, for example, user interface 120 is comprised of a plurality of executable instructions which are communicated to a computing device 114 to render a web page on a display of the computing device. In alternate embodiment, user interface 120 is comprised of a touch tone response system, wherein a user of a telephony computing device 120 may interact with the features and services of financial service center 120. Depending on the computing device 114 used to access the system, and the nature of the interface network 110 and 112, user interface 120 may be transmitted in an encrypted form to protect the sensitive nature of a user's account information. In the web page embodiment, described above, the web page would typically be encrypted and sent to the appropriate computing device 114. According to one embodiment, for example, the page is encyrpted according to the Secure Server Language (SSL)

As shown, businesses 106(a) . . . (n) may access (and be accessed from) the network 100 in any of a number of alternate means. According to one implementation, business 106(a) may utilize a legacy biller integration system (BIS) 122 to send batch billing statements to financial service center 102 for presentment to and payment by consumers 104(a) . . . (n). Examples of innovative EBPP systems incorporating BIS technology are provided in U.S. patent application Ser. No. 08/734,518 to Remington, et al. described above; U.S. patent application Ser. No. 08/936,235 to Campbell, et al., entitled System and Method for Designing Responses for Electronic Billing Statements; U.S. patent application Ser. No. 08/926,156 to Dent, et al. (now U.S. Pat. No. 6,128,603), entitled Consumer-Based System and Method for Managing and Paying Electronic Billing Statements; U.S. patent Ser. No. 08/880,125 to Campbell, et al., entitled System and Method for Designing and Distributing Customized Electronic Billing Statements; U.S. patent application Ser. No. 09/093,959 to Heindel, et al., entitled Distributed Electronic Billing System with Gateway Interfacing Biller and Service Center; and U.S. patent application Ser. No. 09/093,958 to Keith, et al., entitled Parcel Manager for Distributed Electronic Billing System the disclosures all of which being expressly incorporated herein by reference.

In alternate embodiments, however, businesses 106 may utilize the innovative features of financial transaction manager 116 to request payment from consumers. That is, a business may utilize the same user interface 120 that consumers use to initiate financial transactions. In this regard, financial transaction manager 116 facilitates use of the electronic financial network 100 by small businesses, sole proprietorships, and the like without having to invest in a technical support staff to structure bills. If an employee/owner can use a web-site they can initiate a request for payment using the financial service center 102. According to one implementation, financial transaction manager 116 provides users with monthly transaction summaries for their accounts. Businesses may, using the customer service features of financial transaction manager, receive more detailed summaries, and can tailor the summaries for their use (i.e., to accommodate financial management/accounting software).

Certain financial transactions performed using the services of financial service center 102 will ultimately be cleared through asset-backed accounts of financial institutions 108(a) . . . (n) associated with the transaction participants. These financial institutions are intended to represent any of a wide variety of financial institutions including, but not limited to, banks, credit unions, brokerage houses, etc. According to one embodiment, financial service center 102 is provided by a financial institution and the accounts 118 are asset backed accounts such that transactions clear nearly instantaneously. In alternate embodiments, the accounts 118 merely represent one or more asset-backed accounts at a financial institution(s). In this alternate embodiment, transactions are cleared through the well known automated clearing house (ACH) network. Other financial transactions may be cleared outside of the ACH system, for example, by through other accounts, e.g., a telephone service account.

The ACH network is a nationwide system that processes electronic payments on behalf of depository financial institutions. The ACH network represents approximately 15,000 of the 20,000 financial institutions in the United States. Although best thought of as a single network, the ACH network actually consists of four interconnected networks owned and operated by four ACH operators: the Federal Reserve, VISA, New York ACH (which provides regional coverage in New York), and Arizona Clearing House in conjunction with Deluxe Data (which provides regional coverage in Arizona). The ACH network is well-known in the art. Thus, in this embodiment, the FSC account 118 may be thought of as a proxy, or front end, for the asset backed financial account.

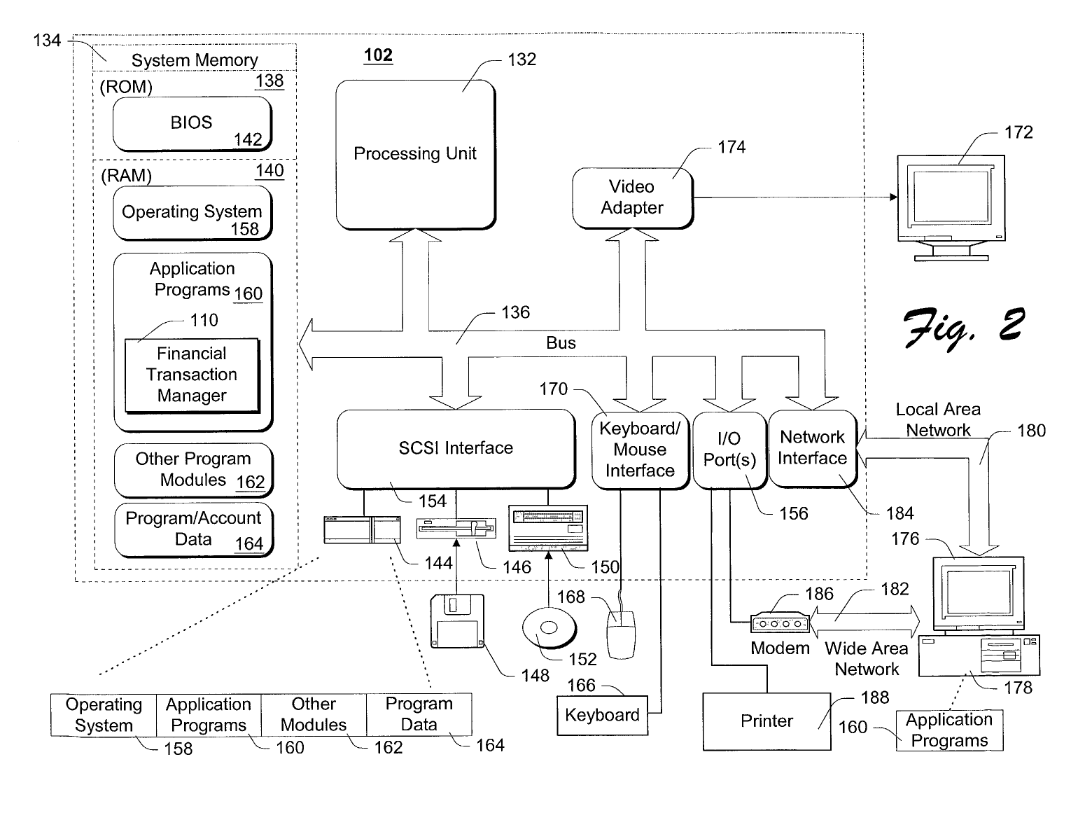

FIG. 2 illustrates an example computer system suitable for use as the financial service center 102 of FIG. 1. It will be evident, from the discussion to follow, that computer 102 is intended to represent any of a class of general or special purpose computing platforms which, when endowed with the innovative financial transaction manager 116, implement the teachings of the present invention in accordance with the first example implementation introduced above. It is to be appreciated that although the financial transaction manager 116 is implemented as a software program, computer system 102 may alternatively support a hardware implementation as well. In this regard, but for the description of financial transaction manager 116, the following description of computer system 102 is intended to be merely illustrative, as computer systems of greater or lesser capability may well be substituted without deviating from the spirit and scope of the present invention.

As shown, computer 102 includes one or more processors or processing units 132, a system memory 134, and a bus 136 that couples various system components including the system memory 134 to processors 132.

The bus 136 represents one or more of any of several types of bus structures, including a memory bus or memory controller, a peripheral bus, an accelerated graphics port, and a processor or local bus using any of a variety of bus architectures. The system memory includes read only memory (ROM) 138 and random access memory (RAM) 140. A basic input/output system (BIOS) 142, containing the basic routines that help to transfer information between elements within computer 102, such as during start-up, is stored in ROM 138. Computer 102 further includes a hard disk drive 144 for reading from and writing to a hard disk, not shown, a magnetic disk drive 146 for reading from and writing to a removable magnetic disk 148, and an optical disk drive 150 for reading from or writing to a removable optical disk 152 such as a CD ROM, DVD ROM or other such optical media. The hard disk drive 144, magnetic disk drive 146, and optical disk drive 150 are connected to the bus 136 by a SCSI interface 154 or some other suitable bus interface. The drives and their associated computer-readable media provide nonvolatile storage of computer readable instructions, data structures, program modules and other data for computer 102.

Although the exemplary environment described herein employs a hard disk 144, a removable magnetic disk 148 and a removable optical disk 152, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used in the exemplary operating environment.

A number of program modules may be stored on the hard disk 144, magnetic disk 148, optical disk 152, ROM 138, or RAM 140, including an operating system 158, one or more application programs 160 including, for example, the innovative financial transaction manager 116 incorporating the teachings of the present invention, other program modules 162 including a runtime environment associated with an advanced programming language incorporating the teachings of the present invention, and program data 164 (e.g., Financial Service Center (FSC) accounts). A user may enter commands and information into computer 102 through input devices such as keyboard 166 and pointing device 168. Other input devices (not shown) may include a microphone, joystick, game pad, satellite dish, scanner, or the like. These and other input devices are connected to the processing unit 132 through an interface 170 that is coupled to bus 136. A monitor 172 or other type of display device is also connected to the bus 136 via an interface, such as a video adapter 174. In addition to the monitor 172, personal computers often include other peripheral output devices (not shown) such as speakers and printers.

As shown, computer 102 operates in a networked environment using logical connections to one or more remote computers, such as a remote computer 176. The remote computer 176 may be another personal computer, a personal digital assistant, a server, a router or other network device, a network “thin-client” PC, a peer device or other common network node, and typically includes many or all of the elements described above relative to computer 102, although only a memory storage device 178 has been illustrated in FIG. 2.

As shown, the logical connections depicted in FIG. 2 include a local area network (LAN) 180 and a wide area network (WAN) 182. Such networking environments are commonplace in offices, enterprise-wide computer networks, Intranets, and the Internet. In one embodiment, remote computer 176 executes an Internet Web browser program such as the “Internet Explorer” Web browser manufactured and distributed by Microsoft Corporation of Redmond, Wash. to access and utilize online services.

When used in a LAN networking environment, computer 102 is connected to the local network 180 through a network interface or adapter 184. When used in a WAN networking environment, computer 102 typically includes a modem 186 or other means for establishing communications over the wide area network 182, such as the Internet. The modem 186, which may be internal or external, is connected to the bus 136 via a input/output (I/O) interface 156. In addition to network connectivity, I/O interface 156 also supports one or more printers 188. In a networked environment, program modules depicted relative to the personal computer 102, or portions thereof, may be stored in the remote memory storage device. It will be appreciated that the network connections shown are exemplary and other means of establishing a communications link between the computers may be used.

Generally, the data processors of computer 102 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the innovative steps described below in conjunction with a microprocessor or other data processor. The invention also includes the computer itself when programmed according to the methods and techniques described below. Furthermore, certain sub-components of the computer may be programmed to perform the functions and steps described below. The invention includes such sub-components when they are programmed as described. In addition, the invention described herein includes data structures, described below, as embodied on various types of memory media.

For purposes of illustration, programs and other executable program components such as the operating system are illustrated herein as discrete blocks, although it is recognized that such programs and components reside at various times in different storage components of the computer, and are executed by the data processor(s) of the computer.

Example Financial Transaction Manager

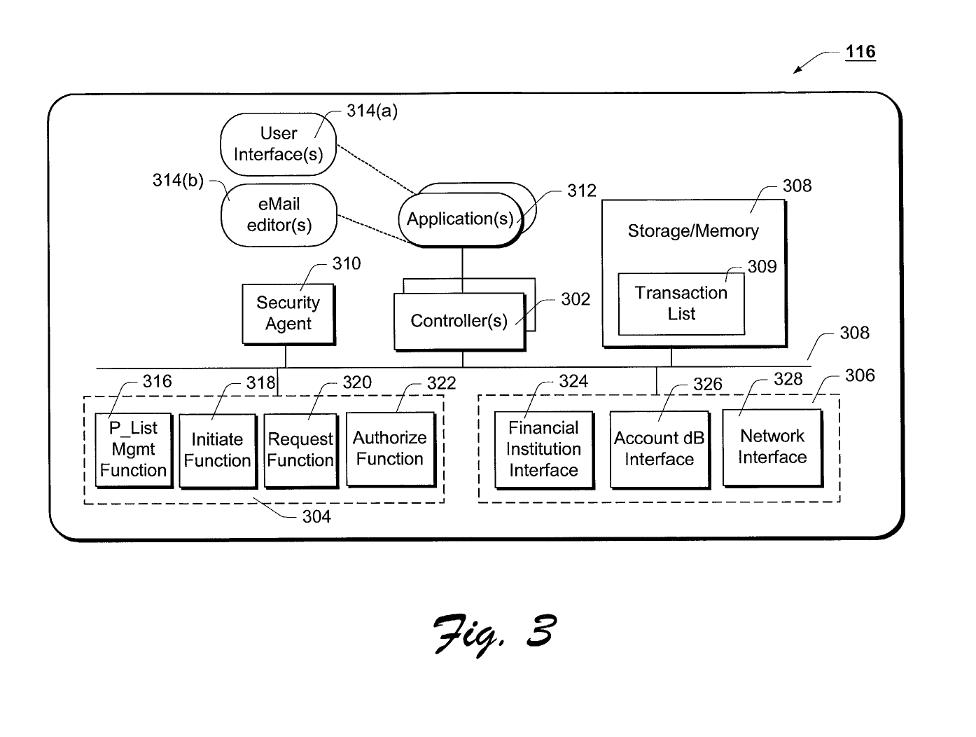

FIG. 3 illustrates a block diagram of an example financial transaction manager 116, incorporating the teachings of the present invention. As shown, financial transaction manager 116 is comprised of one or more controller(s) 302, a financial manager function(s) 304, network interface(s) 306, storage device/memory 308 including a transaction list 309, a security agent 310 and, optionally, one or more applications 312 including, for example, one or more user interface(s) 314(a) and/or eMail editor(s) 314(b), communicatively coupled as shown. For ease of explanation and illustration, financial transaction manager is shown in FIG. 3 as a plurality of functional blocks. It is to be appreciated, however, that one or more of the individual blocks may well be combined into a single block. Moreover, financial transaction manager 116 may well be implemented as a plurality of executable functions in software which, when executed, implement the services of financial transaction manager to be described.

Controller(s) 302 are intended to represent a wide variety of control and processing devices known in the art. Controller 302 manages the invocation of financial transaction services of the financial service center (FSC) 102. In this regard, controller 302 is responsive to user input received via user interface 120 to selectively invoke services of the financial manager suite 304. This communication is performed through appropriate ones of the network interface(s) 306 to be described more fully below. Moreover, in an alternate embodiment, controller 302 selectively invokes its own user interface 314(a) . . . (b), obviating the need for a user interface at the financial service center level.

Controller 302 selectively invokes services of the financial manager suite 304 in response to user interaction with a user interface. As shown, the financial manager functions 304 include a participant list (P_List) management function 316, an initiate payment function 318, a request payment function 320 and an authorize payment function 322. The p_list management function 316 enables individual users to register for the services of the financial service center 102. In so doing, the p_list management function 316 establishes a financial service center (FSC) account which is stored in a database of such accounts in storage device 118. In addition, the p_list manager enables a user to compile a list (i.e., add, subtract, modify) of other users with which they perform financial transactions. The list is maintained in the FSC account and provided to the user when subsequent financial transactions are performed.

The initiate payment function 318 is invoked by controller 302 when a user indicates that they wish to initiate a payment to another. Unlike prior art EBPP systems, the financial transaction manager enables this payment to be made to one who is not a user of the financial service center 102. If the “payee” is a user of the financial service center 102, the user initiating the transaction (“payer”) identifies the payee from their participant list, or alternatively, from a master list of users. The user provides information regarding the amount to be paid and any additional information describing the transaction (for the benefit of the payee), and issues the transaction. Once the payer has issued the transaction, it is posted in the payee (recipients) FSC account. If the “payee” is not a user of the FSC 102, alternate means of notification and payment are utilized, and will be described in greater detail below.

The request payment function 320 is a means by which a user can “bill” another. As above, the request payment function 320 may well be invoked by a user to solicit a payment from one who is not a user of the financial service center 102 using an appropriate one of a plurality of alternate request means. If, however, the recipient of the request (payer) is a user of financial service center 102, the requester (payee) provides information requested by a user interface associated with the function and issues the request. Once authorized, the requested funds will be posted in the requestor (payee) FSC account.

The authorize payment function 322 enables a user to authorize payment in response to the request of another (e.g., a bill). As alluded to above, once a request for payment is received, a user will authorize payment of the request. The authorize function relies on features of the security agent 310 to ensure that the one requesting the funds is actually associated with the account to which the funds are to be deposited. In this regard, security agent 310 performs an important function of ensuring that the integrity of the financial service center 102. Security agent 310 is responsible for ensuring the security of communications between financial service center 102 and any user using any of a myriad of available encryption schemes. In addition, security agent 310 is also responsible for “policing” the authenticity of users and the use of the financial service center. According to one implementation, security agent 310 receives a receipt that the payment was received by the payee, and checks that the payee information in the receipt matches the information in the transmittal. Upon verification of the payee, security agent 310 passes the receipt information to the manager for display to the user.

As introduced above, financial transaction manager 116 includes a number of interfaces 306 enabling FTM 116 to interface with a variety of peripherals and networks. Thus, according to one implementation, FTM 116 includes a financial institution interface 324, account database interface 326 and a network interface 328. As used herein, the financial institution interface 324 enables the FTM 116 to communicate with financial institutions in a format suitable for clearing transactions via the ACH. The account dB interface 326 enables controller 302 to communicate with external storage devices in a language employed by the database (e.g., SQL, etc.). The network interface 328 is the means by which controller 302 interfaces with the user interface 120 and financial service center users.

FIG. 4 is a block diagram of an example computing device 114 suitable for use within network 100 to enable users to access and utilize the features of financial service center 102, according to one embodiment of the present invention. As shown, computing device 114 includes one or more processing unit(s) 402, a non-volatile memory device 404, a display device 406, an input device 408, input/output (I/O) port(s) 410, volatile system memory 412 and a storage device 414 including an client application 416 which, when executed, enables the computing device 114 to interface with the financial service center 102 over a network 100.

As described above, except for the interaction with financial service center 102, computing device 114 is intended to represent a wide variety of computing devices known in the art, and does not require any special features in order to access and utilize the innovative services of financial service center 102. Similarly, the functional blocks 402-426 are each intended to represent any of a plurality of devices which perform these functions and, thus, need not be described further.

Example Data Structure

As used herein, data source 118 is each intended to represent any of a number of storage devices/media for storing data structures. For example, data source 118 may well be comprised of one or more of a floppy disk within a floppy disk drive, a hard disk drive, a redundant array of independent drives (RAID) system, a compact disk (CD) inserted within an accessible CD player, a digital versatile disk (DVD) inserted within an accessible DVD player, a magnetic tape within a tape drive, and the like. In addition, although depicted as an integrated element of financial service center 102, those skilled in the art will appreciate that use of a remotely accessible storage device may also be utilized in accordance with the spirit and scope of the present invention. Such storage devices/media are well known to those skilled in the art and, thus, need not be described further.

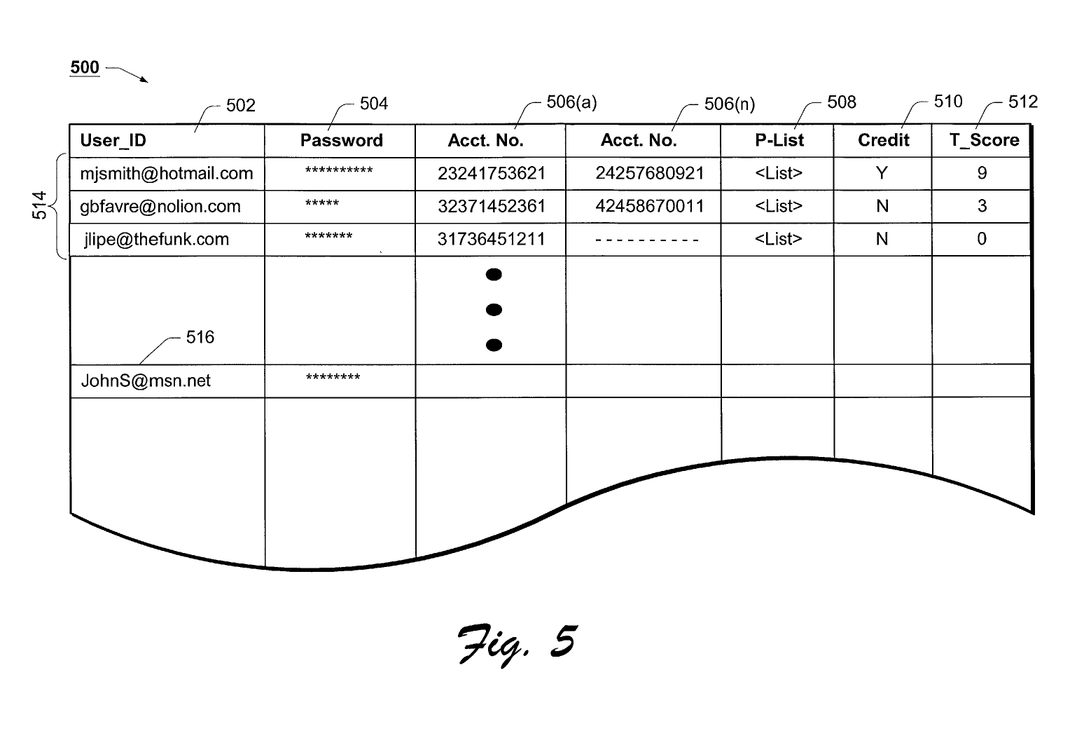

As introduced above, the financial service center account information is stored and accessible from a suitable data source, e.g., data source 118 by financial transaction manager 116. One example of a data structure suitable for use as an FSC account file/database is presented with reference to FIG. 5.

FIG. 5 graphically illustrates an example data structure suitable for use as an FSC account database/file populated with information regarding a plurality of users of FSC 102. FSC account file 500 is used by FSC 102 to maintain a list of registered users and their associated financial account information to support the financial services provided by financial transaction manager 116. As shown, FSC account file 500 includes a number of fields including one or more of a user_ID field 502, password information 504, one or more financial institution account numbers 506(a) . . . (n), the user's participant list 508, an indication of whether to extend credit 510, and a growing trust model score 512. It will be appreciated that, FSC account files 500 of greater or lesser complexity may well be used without deviating from the spirit of the present invention. Indeed, such FSC account files are anticipated within the teachings of the present invention.

As used herein, the user_ID field 502 and the password information field 504 enable financial transaction manager to verify the identity of a user requesting access to an account. In this regard, the user_ID/password combination must be unique to a single individual. A number of user_ID and password criteria may be used to satisfy the uniqueness criteria. In one implementation, for example, a user's Microsoft Passport ID (email address/password combination) are used to uniquely identify the individual. In addition, the FSC account file may well contain additional user information such as, for example, an address, a telephone number, and/or additional credit history information (not shown).

The financial institution account numbers 506(a) . . . (n) provide a link to the bank/brokerage accounts which store the financial assets to support the financial transactions of the user. In this regard, the financial institution (FI) accounts are intended to represent any of a wide variety of such accounts known in the art including, but not limited to, savings accounts, checking accounts, money market accounts, brokerage accounts and the like. In one embodiment, the financial service center 102 provides its users with an FI account (i.e., an integrated FSC/FI account), enabling users to deposit and withdraw funds from the FSC account itself.

The P_list field 508 is populated with a list of individuals with whom the user conducts regular financial transactions using the FSC 102. It should be noted that the P_list field 508 may well contain user's and non-user's of FSC 102. That is, a user is not limited to conducting financial transactions with another user of the FSC 102. In one implementation, financial transaction manager 116 automatically adds/subtracts participants from P_list 508 based, at least in part, on the number of transactions with the participant over a certain period of time. In such an implementation, the individual user can always add/subtract participants to/from the P_list 508 (referred to as “scrubbing” the P_list).

The Credit field 510 provides an indication of whether FTM 116 may extend credit to an identified user. In one implementation, this determination is simply made based on whether a credit account has been identified as an account number 506(a) . . . (n). In an alternate implementation, FSC 102 may also extend credit to a user based, at least in part, on a user's score in a growing trust model, reflected in T_score field 512. In this implementation, to be described more fully below, financial transaction manager maintains a T_score for each user based, at least in part, on the number of transactions performed, the number of transactions involving insufficient funds, the amount of money involved in the transactions, etc. If the T_score exceeds a threshold, FTM 116 may extend credit to the user backed by FSC 102 itself.

FIG. 6 is a graphical representation of a data structure incorporating an example transaction list, according to one implementation of the present invention. According to the illustrated example implementation depicted in FIG. 6, transaction list 310 includes a transaction identification field 552, an initiator identifier 554, a recipient identifier 556, an amount field 558, a status field 560, and an data field 562. As introduced above, each transaction through the system is assigned a unique identifier, stored in transaction identification field 552. At least the initiator and recipient information is maintained (554, 556), although information regarding other/additional participants may also be retained. The amount field 558 identifies the amount of money involved in the transaction, while the status field shows the current status of the transaction (e.g., open, pending, closed). The data field 562 denotes the date in which the transaction was last updated.

Example User Interface

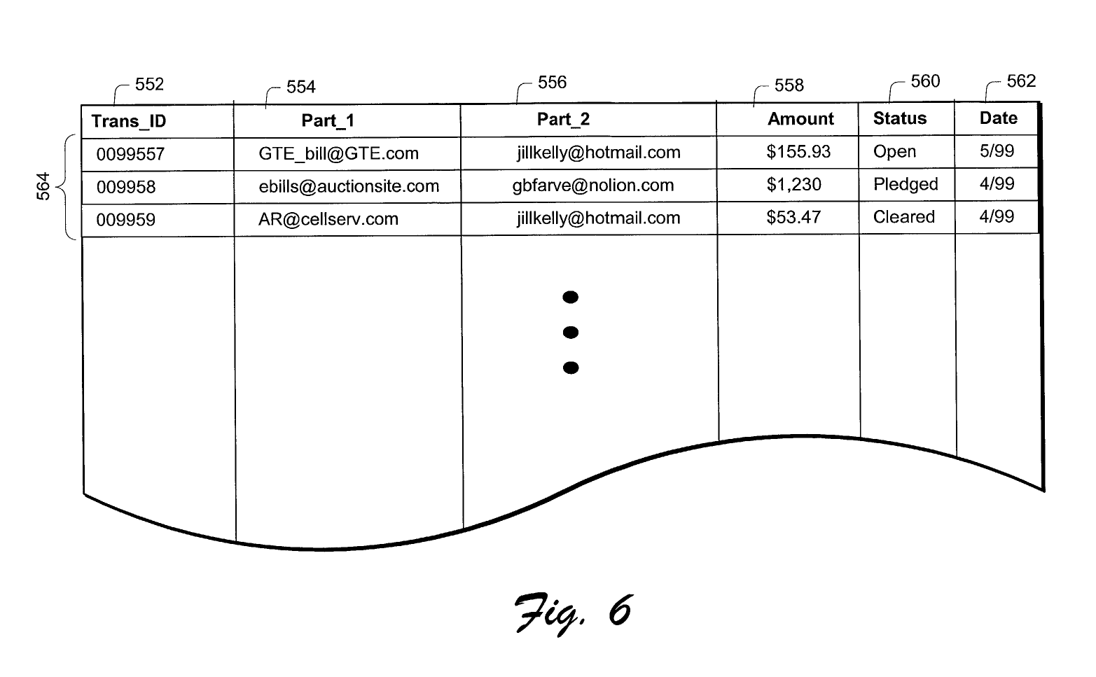

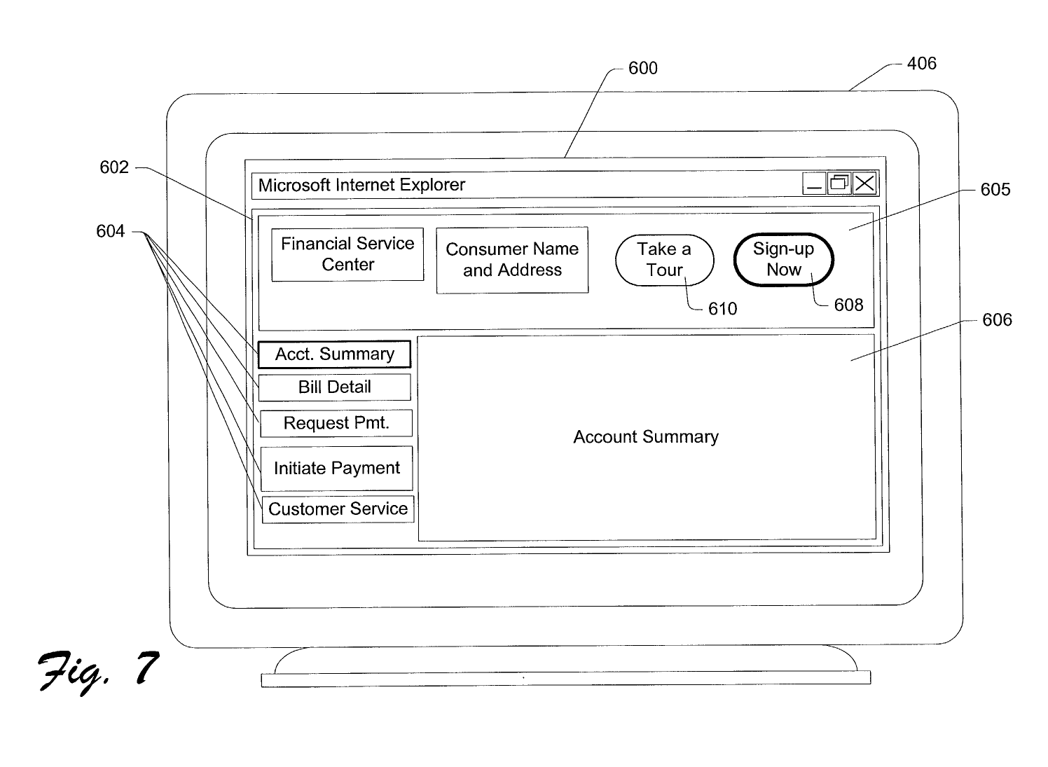

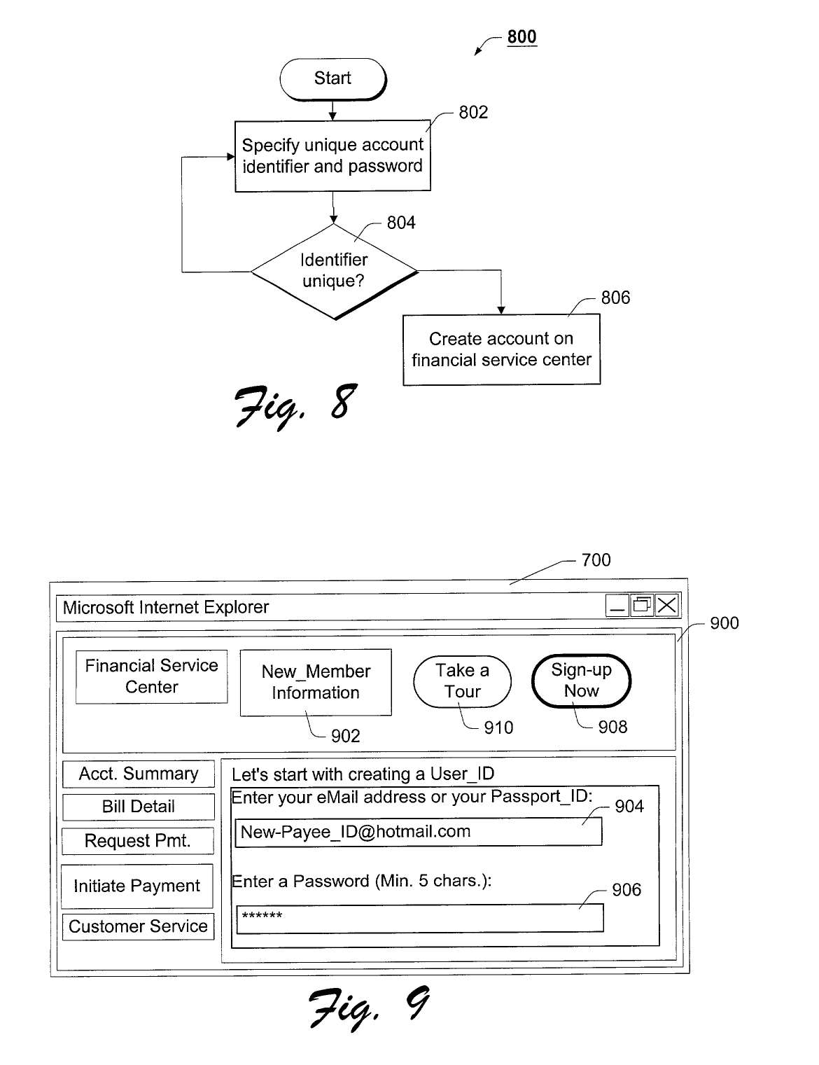

FIG. 7 shows an example illustration of a graphical user interface with a billing statement 602 rendered on a display 406 of a computing device 114. In this example, the billing statement 602 is written in a “markup language,” such as HTML (Hypertext Markup Language). HTML is a subset of SGML (Standard Generalized Markup Language), a language formally defined as “a language for document representation that formalizes markup and frees it of system and processing dependencies.” HTML documents are compatible with the World Wide Web. The HTML billing statement 602 is rendered by an Internet browser application 600, such as the Internet Explorer browser from Microsoft Corporation, which executes on the consumer's computer.

The billing statement 602 is rendered according to the template design. In this example, the billing statement has a banner stripe 605 across the top of the screen to show biller and consumer information. The banner stripe 605 contains various fields, including a resource field for the logo resource and a data field for the consumer's name and address, and buttons such as registration button 608 and virtual tour button 610.

The billing statement 602 has multiple softkeys or buttons 604 that form tabbed navigation points to facilitate quick movement from one section of the bill to another. As will be described in detail below, selection of one of these virtual keys invokes a corresponding function or feature of FTM 116. In this example, there is a “Summary” tab that references the billing page shown in the figure. Activation of a “Details” tab (via a mouse pointer, for example) changes the screen from the summary page to one or more pages itemizing the billing transactions. A “Request Payment tab that selects a user interface to issue a bill to another. The “Initiate Payment” button invokes a payment user interface wherein the user can issue a payment to an entity identified within the UI. The “Consumer Service” tab switches to a page giving instructions on how to access consumer service.

The billing statement 602 has a main body 606 that contains numerous data fields for the billing particulars. The data presented in the body depend on the particular UI being presented. On the “Details” page, to be described more fully below, the data fields in the body 606 might include line items detailing a purchase date, purchase order number, invoice number, item number, description of item, quantity, price, total, tax, and amount due.

The billing statement in FIG. 6 is merely one example. There are infinitely many ways to organize and present data. In addition, the billing statement may contain other items, such as embedded hyperlinks, executable code, and pop-up dialog boxes, which provide additional design flexibility and customization. The biller can essentially create any aesthetics, organization, and detail that it prefers.

Moreover, as alluded to above, although user interface 600 is depicted as a graphical user interface (GUI), any number of alternate user interfaces may well be invoked by FSC 102 to suit the particular requirements of an accessing computing device. In alternate embodiments, for example, a touch-tone audio-based user interface may well be employed to enable one using a cellular telephone to access and utilize the features of FSC 102. Thus, any number of alternate user interfaces may well be used without deviating from the spirit and scope of the present invention.

Example Operation and Implementation

Having introduced the operating environment and functional elements of the innovative financial service center 102 with reference to FIGS. 1-7, above, the operation of the system will now be developed more fully below with reference to FIGS. 8-21.

As alluded to above, the FSC102 utilizes a unique user_ID and password combination to uniquely identify users of the system. Thus, when first accessing the FSC 102, a user must enter their user_ID and password before they may proceed to utilize the services of FSC 102. Once logged in, FSC 102 establishes a secure connection between the user and the FSC to insure the confidential nature of the information and transactions. In one embodiment, the FSC 102 establishes a connectionless session using the secure hypertext transfer protocol (HTTPS).

FSC Registration

FIGS. 8 and 9 illustrate an example method and associated user interface for registering with and using the financial service center (FSC) 102, according to one embodiment of the present invention. As shown, the method begins when a prospective user has selected the sign-up now button 608 of the user interface 120 presented by the FSC 102. Upon selecting button 608, the user is presented with a registration graphical user interface 900 comprising a user information field(s) 902, a user_ID field 904 and a password field 906.

In step 802 of FIG. 8, the user specifies a unique account identifier and password in the appropriate fields 904 and 906 of GUI 900. As alluded to above, the user_ID may well be an email address, a Microsoft Passport ID, and the like. In step 804, financial transaction manager 116 accesses the FSC account information 118 to determine whether the selected user_ID is, indeed, unique. If not, the prospective user is prompted to provide another user_ID in field 904, as the registration process returns to step 802.

If, in step 804, financial transaction manager 116 determines that the user_ID provided in field 904 is unique, financial transaction manager establishes a record in the FSC account database/file for the new user. According to one implementation, the new user will be required to provide at least one financial institution (FI) account as well in order to utilize the services of financial service center 102.

Initiate Payment

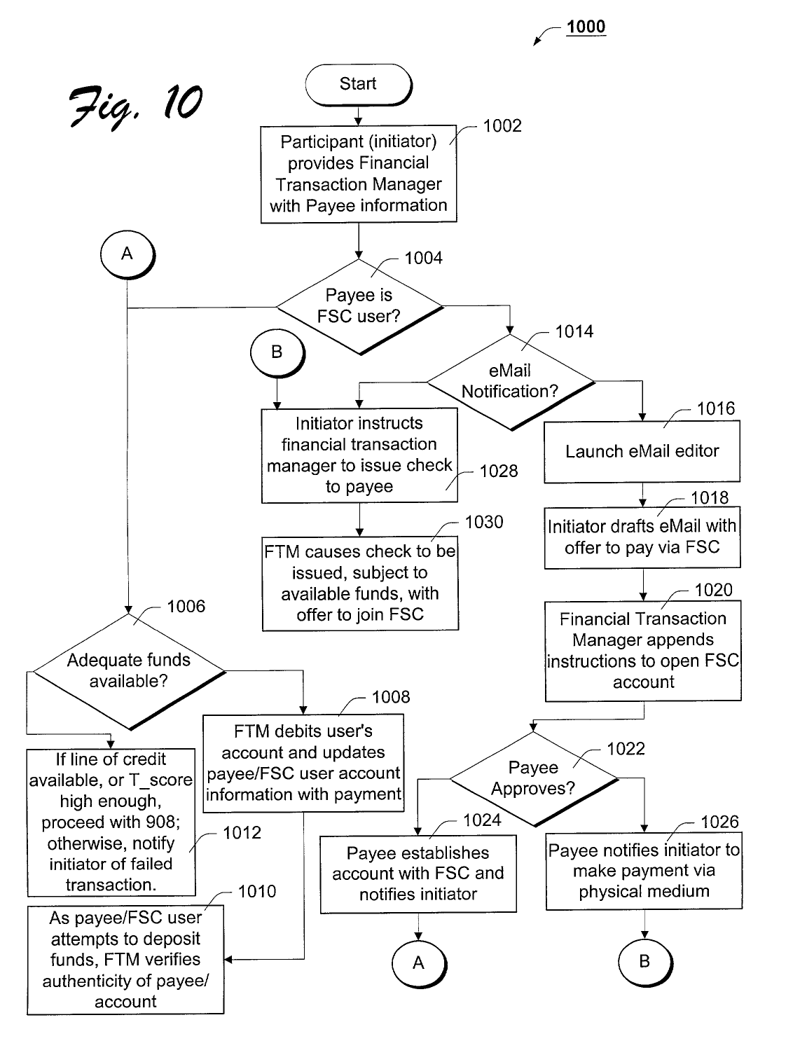

Turning now to FIGS. 10-14, an example method and associated graphical user interface(s) to initiate a payment with another is depicted, according to one embodiment of the present invention. As shown, the method of FIG. 10 is invoked when a user selects the initiate/authorize payment button 604 from the GUI 600. In response, financial transaction manager 116 invokes the initiate payment function 318, whereupon the user is provided with an initiate payment UI 1000, depicted in FIG. 11. According to one embodiment, the initiate function 318 is invoked in response to selection of the initiate/authorize payment button 604 when the user has not selected a displayed transaction within the main UI 600. That is, the authorize function 320 is only invoked when a user has selected a transaction (i.e., requested payment notice) in the main UI 600 and selects the initiate/authorize button 604.

As shown, the initiate payment UI 1100 includes a user information banner 1102, a participant selection (P_list) drop-down menu 1104, an account selection drop-down menu 1106, a function drop-down menu 1108, a value field 1110, a button to issue the payment 1112, a new payee button 1114, a cancel button 1116 and a transaction identifier (trans_ID) field 1118. The transaction identifier is created by the FTM 116 for each individual transaction, and uniquely identifies the information associated with each transaction. In one embodiment, for example, financial transaction manager 116 maintains a transaction list 309, individually identifiable by the transaction number that contains transaction information, and the status of the transaction.

The banner field 1102 includes information regarding the accessing user. In accordance with one aspect of the present invention, the information provided in the banner field is selectively modifiable by the user. In one embodiment, for example, the user's name and address are provided in field 1120, and the user can update this information by selecting button 1122. In this way, the user may limit the amount of personal information is provided to the designated payee when the payment is issued.

With reference to FIG. 10, the example initiate payment method 1000 begins in step 1002 wherein the user (initiator) provides financial transaction manager 116 with information regarding the payment. According to the illustrated example embodiment, the user provides this information, i.e., payee name (or user_ID), the amount of the payment and the account from which the funds are to be drawn using the respective drop-down menus and fields 1104-1116 of UI 1100.

According to the illustrated example embodiment of FIG. 11, the user may select a user from a participant list 1104, or select a new payee by selecting button 1110. When the new payee button 1110 is selected, the user may select another user from a list provided by financial transaction manager 116 (developed from the FSC account database/file 118), or identify a non-user of the system for payment (e.g., via check).

In step 1004, FTM 116 determines whether the identified payee is a FSC user. If FTM 116 determines that the payee is an FSC user, FTM 116 determines whether adequate funds are available within the account identified in 1106 to cover the requested transaction, step 1006. If so, FTM 116 debits the identified payer's account (1106) and updates the FSC account of the payee/FSC user with information regarding the payment information, step 1008. In step 1010, as the payee/FSC user attempts to move the funds into a FI account, i.e., deposit the funds with a bank account (to be described more fully below), FTM 116 confirms that the account into which the funds are deposited is, indeed, associated with the correct payee. That is, the FTM 116 confirms that the intended payee is actually the one receiving the funds, and thereby protects the initiating user from someone masquerading as the payee/FSC user.

If, in step 1006, FTM 116 determines that inadequate funds are available, FTM 116 determines whether the initiator has a line of credit which may be accessed, or whether the T_score is high enough that the FSC 102 will provide credit to accommodate the transaction. As described above, the user may specify a credit account in the FSC account 118 to draw from to honor such transactions. Moreover, in certain implementations, the entity providing the financial service center 102 may also be willing to extend credit to honor transactions that might otherwise fail due to insufficient funds. In this instance, the FSC 102 makes the decision of whether to extend such credit is an objective one made according to a T_score.

In one implementation, the T_score is calculated according to a growing trust model that attempts to quantify the user's credit worthiness based on prior transactions, e.g., the amount of prior transactions, the amount of the present transaction, the number of times the account has been overdrawn, the amount to which this transaction would overdraw the account, etc. In an alternate embodiment, the T_score reflects a score obtained from one or more credit bureaus.

If the FTM 116 elects to extend credit to cover otherwise insufficient funds, the process continues with step 1008. Alternatively, if the FTM 116 cannot extend credit to cover the transaction, the transaction fails and the user/initiator is so informed.

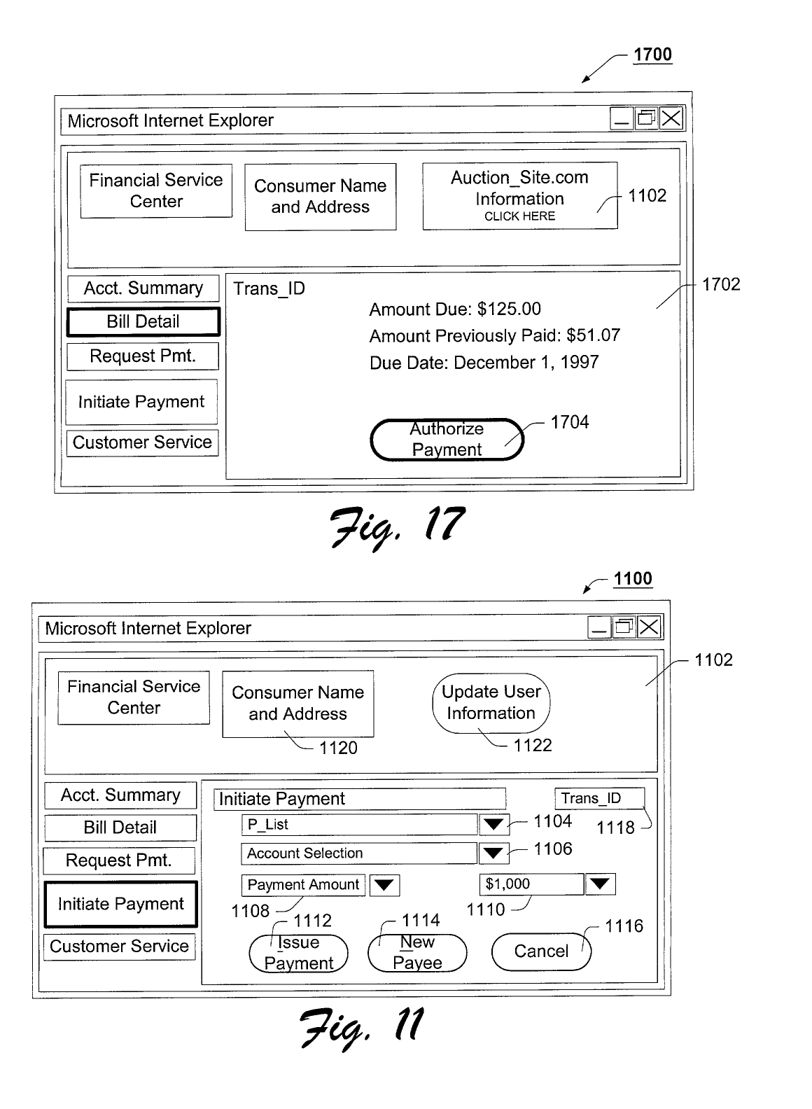

Returning to step 1004, if the payee is not an FSC user, FTM 116 presents the user with a couple of alternate means for making the payment. According to one implementation, FTM 116 prompts the user for an email address of the payee to determine whether payment notification may be made via email, step 1014. If the email address is known, FTM 116 launches an email editor (e.g., email editor 314(b)) in which to create an email message notifying the payee of the payment, step 1016. In step 1018, the user (initiator) drafts the email with the offer to pay the payee via the FSC. An example FTM editor UI 1200 is provided with reference to FIG. 12.

FIG. 12 graphically represents an email editor user interface to enable a user to draft an email message to a payee, according to one embodiment of the present invention. As shown, the UI 1200 includes a title bar 1202, which provides instructions on how to compose the email, a payee email address field 1204, the user's email address field 1106, a user message field 1108, an FSC message field 1210, and implementation buttons including a button to send the email 1212.

In the user message field 1208, the user (initiator) types in a short message to notify the designated payee that the user wants to make a payment to the payee. This message may be as short or as long as the user desires. The FSC message field 1210 includes instructions on how to proceed to claim the funds by registering with the FSC 102 (see, e.g., FIGS. 8 and 9).

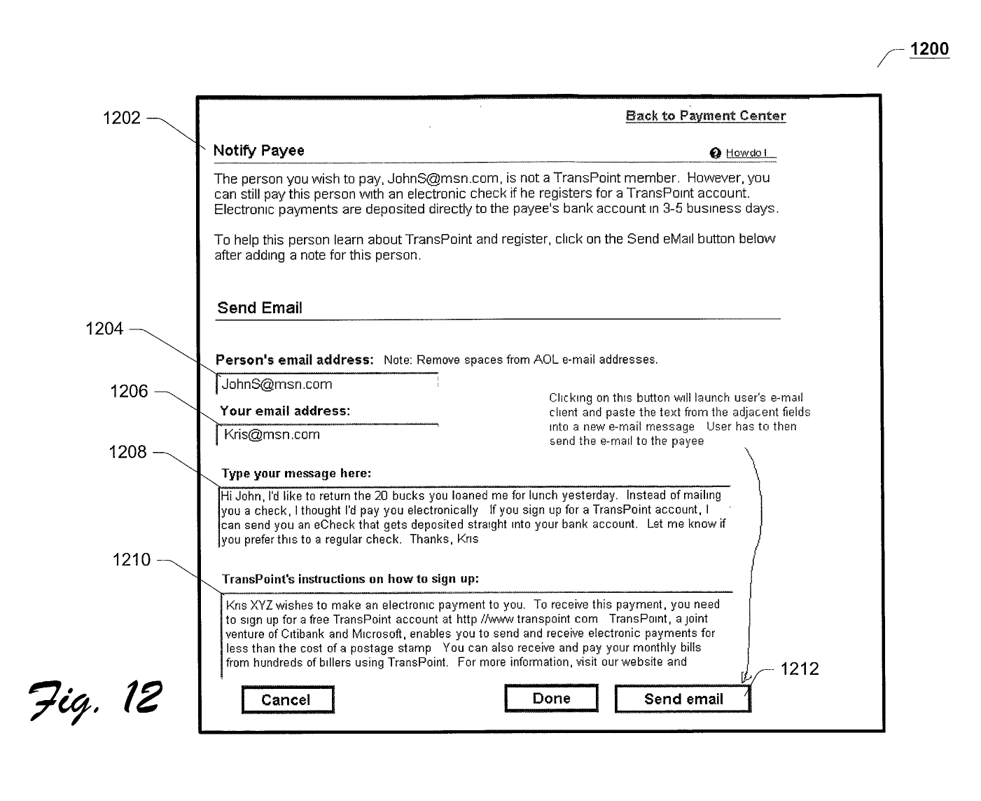

In step 1028 of FIG. 10, the FTM 116 creates an email message from the information provided in UI 1200, appending instructions on how to open an FSC account (i.e., the FSC message field 1210) to the message and sends the message to the designated destination. An example of just such an email message is presented with reference to FIG. 13.

FIG. 13 is a graphical representation of an email received by the designated payee. As shown, email message 1300 includes header information 1302 which specifically denotes the user (initiator). By sending the email in the name of the user (initiator) rather than the name of the service (FSC 102), it is less likely to be interpreted by the payee as an unsolicited offer to join service (e.g., junk e-mail, or spam). In addition, email 1300 includes a personalized message from the user 1304 as well as instructions on how to join the service and access the funds electronically 1306. The personalized user message 1304 is comprised of at least the user message field 1208, and may also include information provided in the initiate payment UI 1100. Instructions 1306 include at least the content of FSC message field 1210. In one embodiment, the email 1300 includes a hyperlink to an application server page of the FSC 102 wherein the payee can register for the service. According to one implementation, the application server page will be pre-populated with known information regarding the payee based on the information retrieved from the transaction list 309 (e.g., email address, a transaction identifier regarding the payment notification, etc.). According to this implementation, the method continues with a registration process (e.g., FIG. 8) followed by transfer of the funds from the user (initiator) account to the newly created account of the payee (steps 1008 and 1010), and notification to the initiator that the transfer has been completed.

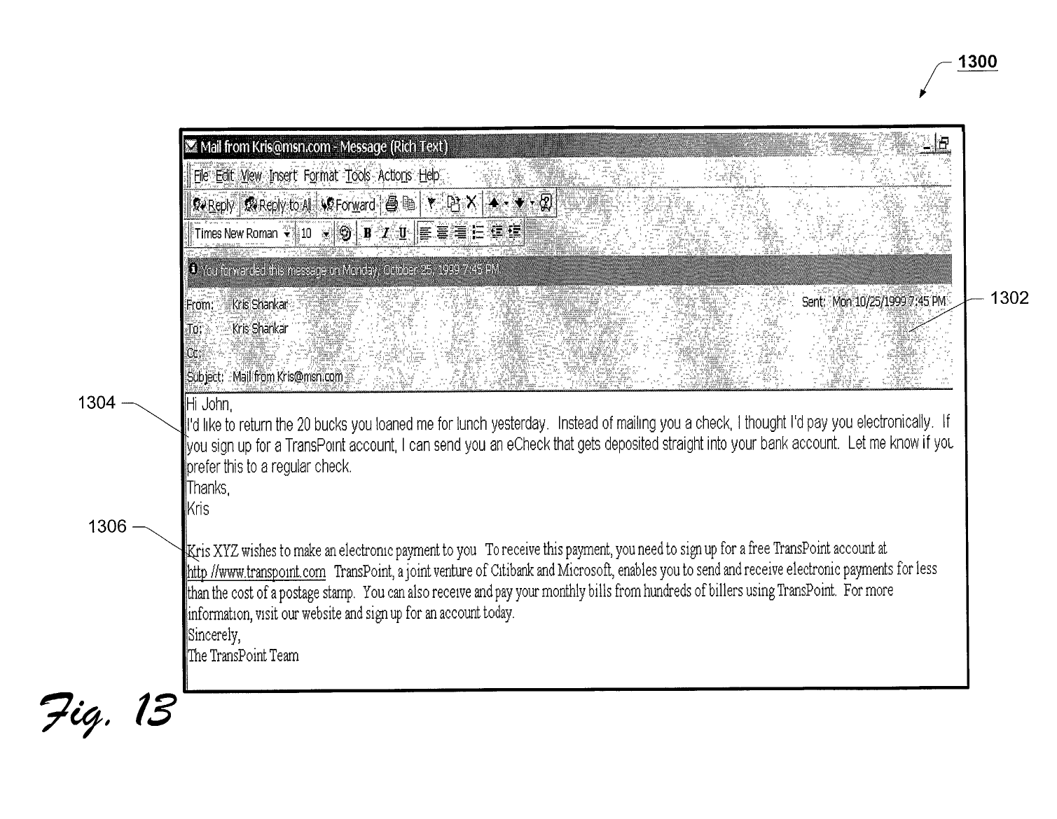

If in step 1022 the payee does not want to receive the payment electronically, the payee so notifies the user (initiator) to make the payment via a physical medium (e.g., a check), step 1026. Thus, if the email address of the payee is not known (1014), or the payee does not want an electronic payment (1026), the initiator instructs FTM 116 to issue a check to payee, step 1028. In response, FTM 116 takes the information received from UI 11000 and causes a check to be printed (e.g., from printer 188 of FSC 102) and sent to payee, subject to available funds, step 1030. An example of a check created by FTM 116 is presented with reference to FIG. 14.

Turning briefly to FIG. 14, a graphical representation of an example check created by FTM 116 is presented, according to one embodiment of the present invention. As shown, the check 1400 includes the name of the payee 1402, the amount of the payment 1404, an account number 1406, and, optionally, another offer 1408 to register with FSC 102. As with the email solicitation above, the offer 1408 printed on the check 1400 may also include an address 1410 wherein the payee may register with FSC 102. The address 1410 may be a uniform resource locator (URL, or internet address), a telephone number, etc.

Request Payment (Issue Bill)

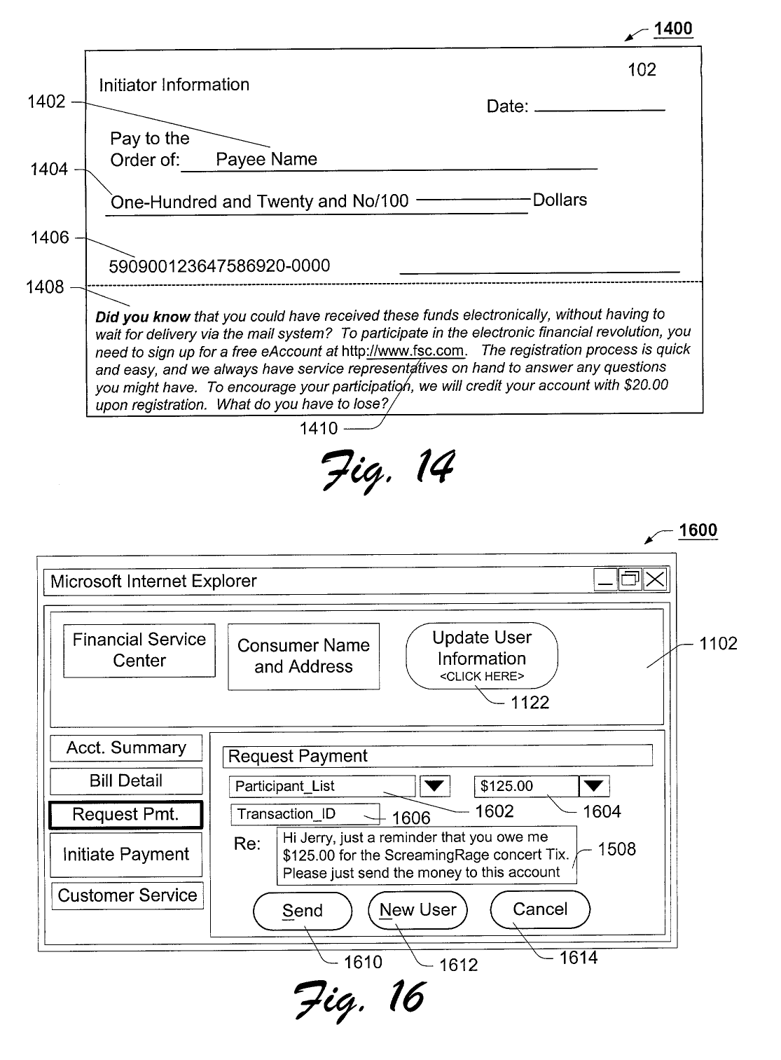

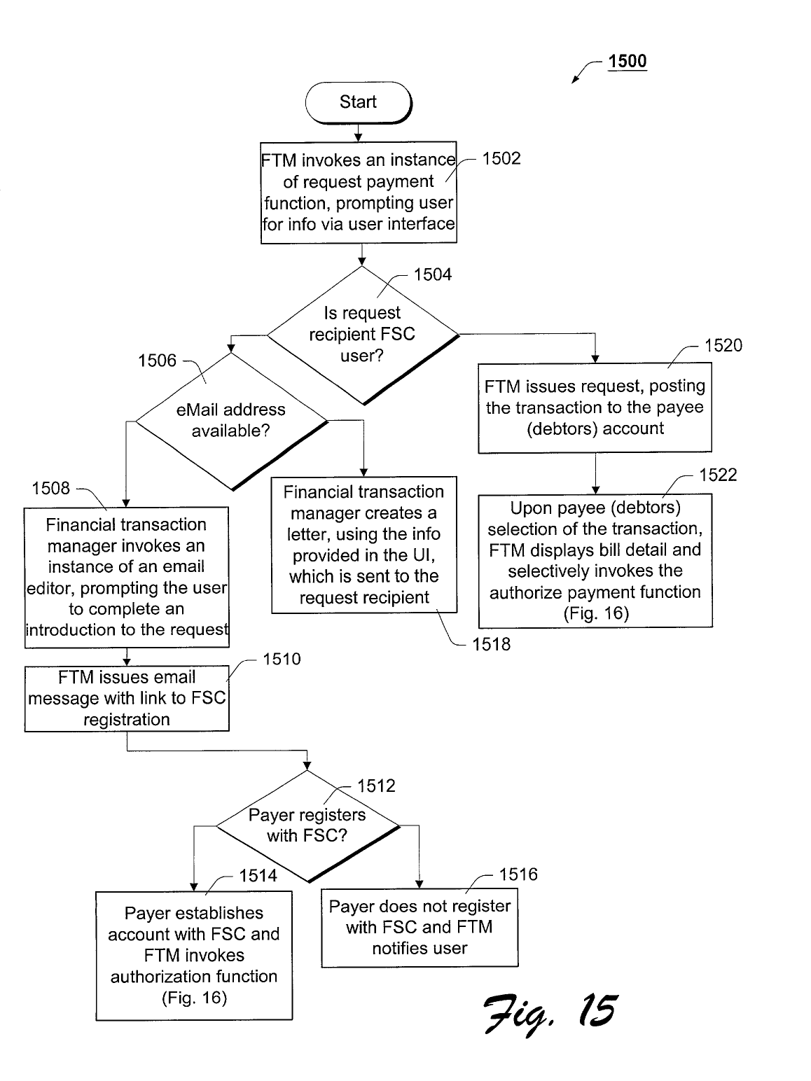

In addition to the legacy bill presentment schemes (e.g., using the BIS 122), financial transaction manager 116 enables any user to request payment from anyone, i.e., user or non-user. An example method 1500 and associated user interface 1600 for requesting a payment is presented with reference to FIGS. 15 and 16, respectively.

FIG. 15 illustrates a flow chart of an example method for requesting payment using the financial service center 102, according to one embodiment of the present invention. As shown, the request payment method 1500 is invoked in response to a user selecting the request payment button 604 of the user interface 120, step 1502. In response, FTM 116 invokes the request payment function 320 which provides the user with a request payment UI 1600, step 1502. An example request payment UI is depicted in FIG. 16.

FIG. 16 graphically represents an example user interface for the request payment function 320 of financial transaction manager 116. As shown, the request payment UI 1600 includes a participant list drop-down menu 1602 to identify the payer (debtor), an amount field 1604, a transaction_ID field 1606, a user message field 1608, a send button 1610, a new user button 1612, and a cancel button 1614. As above, the request payment UI 1600 includes a banner 1002, wherein the requesting user can update 1022 the user information provided to the payer (debtor).

Once the requested information has been provided, FTM 116 determines whether the payee (debtor) is an FSC user, step 1504. If the identified payee is not an FSC user, or the user has selected the new user button 1612, the FTM 116 prompts the user as to whether the payee's email address is known, step 1510. If the email address is known, the FTM 116 invokes an instance of an email editor (314(b)) to construct an email message requesting payment. According to one implementation, FTM 116 includes a solicitation to the payer to register with FSC 102 and make the payment electronically by including a hyperlink in the email to a web page to register for the services of FSC 102. As above, the hyperlink includes information regarding the information transaction identifier to enable the new user to complete the transaction electronically upon successfully registering with FSC 102. In step 1510, FTM 116 issues the email message to the designated payee/debtor.

In step 1512, FTM 116 determines whether the payer has registered with the FSC 102. If so, the FTM 116 invokes an instance of the authorization function 322 to authorize payment of the bill, step 1514. If, however, the payer does not register within a certain period of time, FTM 116 concludes that the payer does not wish to make the payment electronically and so notifies the requesting user (payee), step 1516.

With continued reference to FIG. 15 and, in particular, step 1504, if the recipient is an FSC user, FTM 116 constructs and issues a payment request from the information provided in request payment UI 1600, posting the transaction to the payee FSC account 118, step 1520. Upon payee selection of the transaction and the bill detail button 604 of the UI, FTM 116 displays bill detail and invokes an instance of the authorize payment function 322 to authorize payment of at least a portion of the bill, step 1516. It will be appreciated that the innovative request payment function 320 provides a cheap and easy solution to enable any user to bill anyone for the repayment of a debt.

In response to selection of the bill payment button 604, FTM 116 presents the user with a user interface depicting the bill detail. An example of just such a UI is presented with reference to FIG. 17

FIG. 17 graphically illustrates an example bill detail UI 1700. As shown, the detail UI 1700 includes information regarding the one issuing the bill 1002, a data display area 1702 and an authorize payment button 1704. The data display area 1702 includes relevant information regarding the bill including, but not limited to the transaction identifier, amount due, date due, and the like. Selection of the authorize payment button 1704 causes the FTM 116 to invoke the authorize payment function 322.

Authorize Payment Function

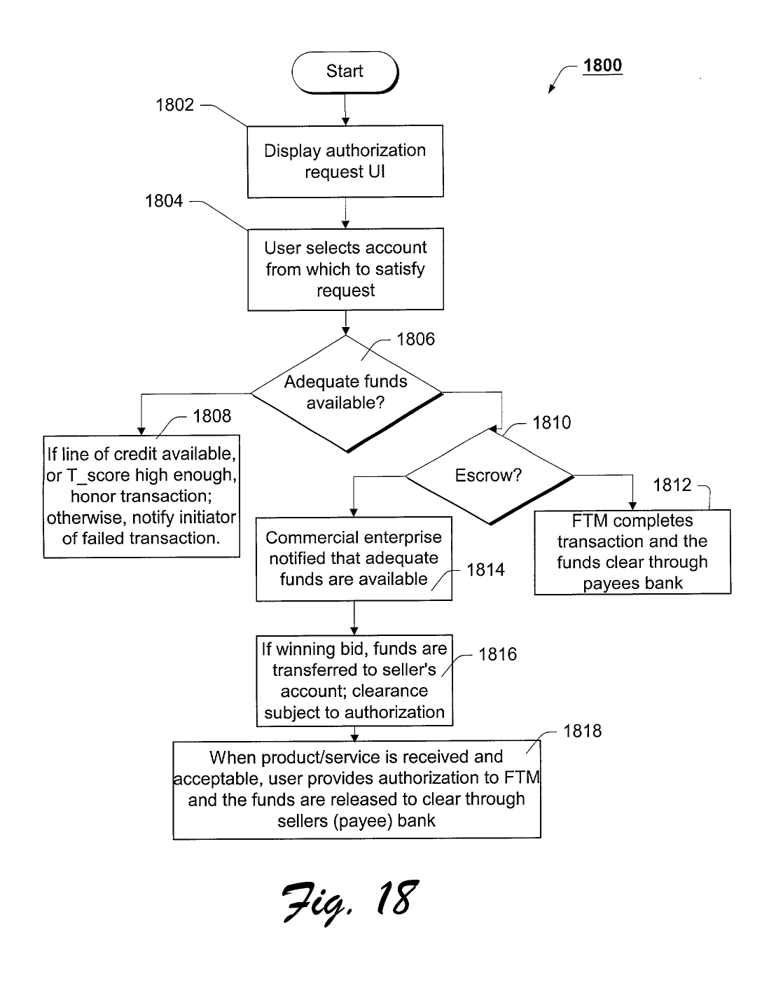

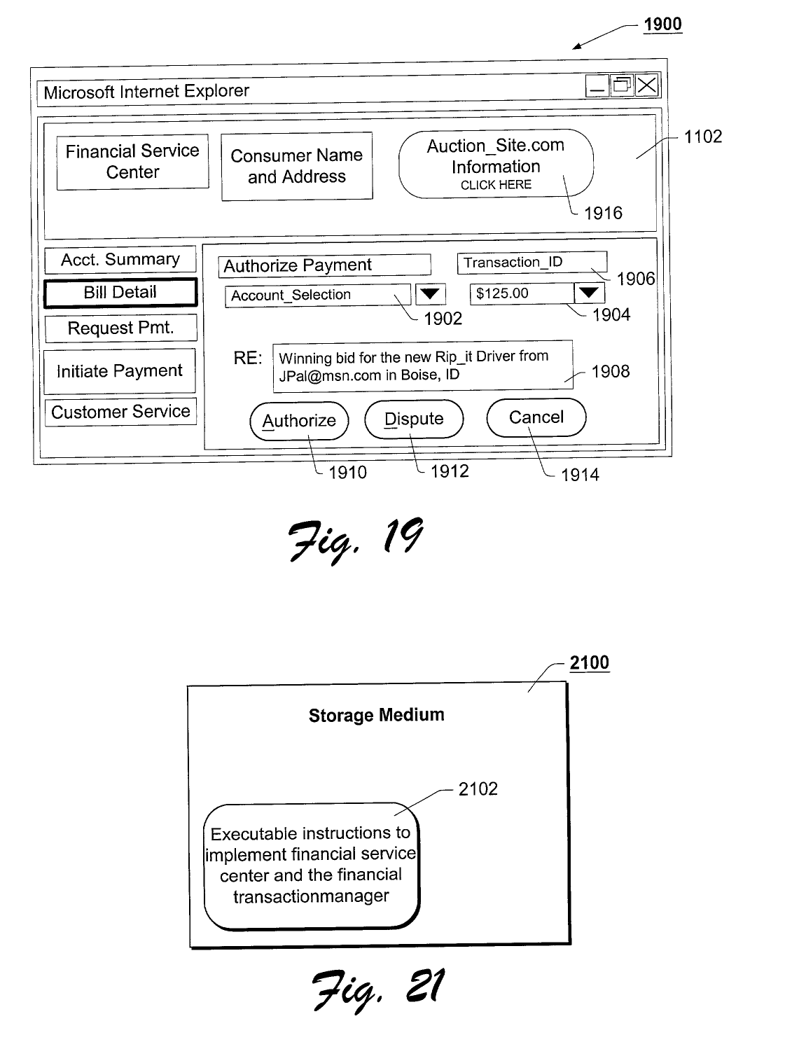

As introduced above, the authorize payment function is invoked to satisfy a request for payment of a bill or other debt. FIG. 18 provides a flow chart of an example method of authorizing a payment of a bill (debt) using the FSC 102. The method begins with FTM 116 presenting a user interface to the user to authorize payment of some or all of the bill, step 1802. An example payment authorization UI 1900 is presented with reference to FIG. 19.

FIG. 19 graphically illustrates an example payment authorization user interface 1900 presented to a user by FTM 116 to authorize payment of a bill, according to one implementation of the present invention. As shown, payment authorization UI 1900 includes an account selection drop-down menu 1902, an amount field 1904, a transaction identifier 1906, a user message field 1908, an authorize button 1910, a dispute button 1912 and a cancel button. As above, the account selection field 1902 allows the user to designate the account from which the funds will be deducted to satisfy the payment. The amount field 1904 enables the user to pay all or some of the requested payment. The transaction identifier 1906 is created by FTM 116 when the initiation request for payment is generated, e.g., in response to the request payment UI 1500 or in response to receiving batch billing statements from the BIS 122 of a business. In the user message field 1908, an indication as to the nature of the bill is presented. User selection of the authorize button 1910 causes FTM 116 to transfer the designated funds to the requesting user's FSC account 118. Selection of the dispute button 1912 instructs FTM 116 to notify the requesting user of a dispute regarding the transaction.

Once FTM 116 presents the payment authorization UI 1900, the user selects a financial institution (FI) account from which the funds to satisfy the request are to be drawn, step 1804. In step 1806, FTM 116 determines whether the account designated in field 1802 has adequate funds to cover the transaction. If not, FTM 116 determines whether a line of credit is available or whether the FSC 102 will extend the necessary credit to cover the transaction based on the T_score 512, discussed above, step 1808. If FTM 116 is not going to extend credit, the authorizing user (payer) is notified that the transaction cannot be completed due to insufficient funds.

If in step 1806 FTM 116 determines that sufficient funds exist, or credit may be extended, FTM 116 determines whether the transaction is an escrow transaction, step 1810. If, for example, the user is using their FSC account 118 to bid on items at an online auction web site, in lieu of a credit card, the user may not wish to finalize the authorization of funds until the product has been received and is acceptable condition. FTM 116 accommodates this desire by providing the online auction site with a quasi-escrow service, according to one aspect of the present invention. If the authorizing user (payer) does not wish to utilize the escrow service, FTM 116 completes the transaction and the funds clear through the payees bank, or other billing process (e.g., through the telephone bill, as discuss above). According to one implementation, all financial transactions conclude with the initiator receiving a receipt for funds transferred. According to this implementation, the receipt may take one or more of many possible forms including, but not limited to, an email notification, notification through an FTM user interface, etc.

If, however, the user does request, or FTM 116 otherwise selects the escrow service, the commercial enterprise (issuing the bill) is notified that adequate funds are available and reserved to cover the transaction (similar to receiving an authorization on a credit card), step 1814. Subsequently, if the authorizing user (payer) has the winning bid, the funds are transferred to the sellers account (provided in the bill) but are not released for clearance through the sellers bank, step 1816. The funds are not released for clearance until the user provides a second authorization, typically after the product is received and deemed acceptable. In which case, the user can initiate final authorization of the bill. Alternately, if such final authorization is not received within a certain time period, FTM 116 may prompt the user for final authorization. In any case, the seller is protected in that the funds are no longer available to the authorizing user until any dispute between the parties is resolved.

Alternate Embodiments

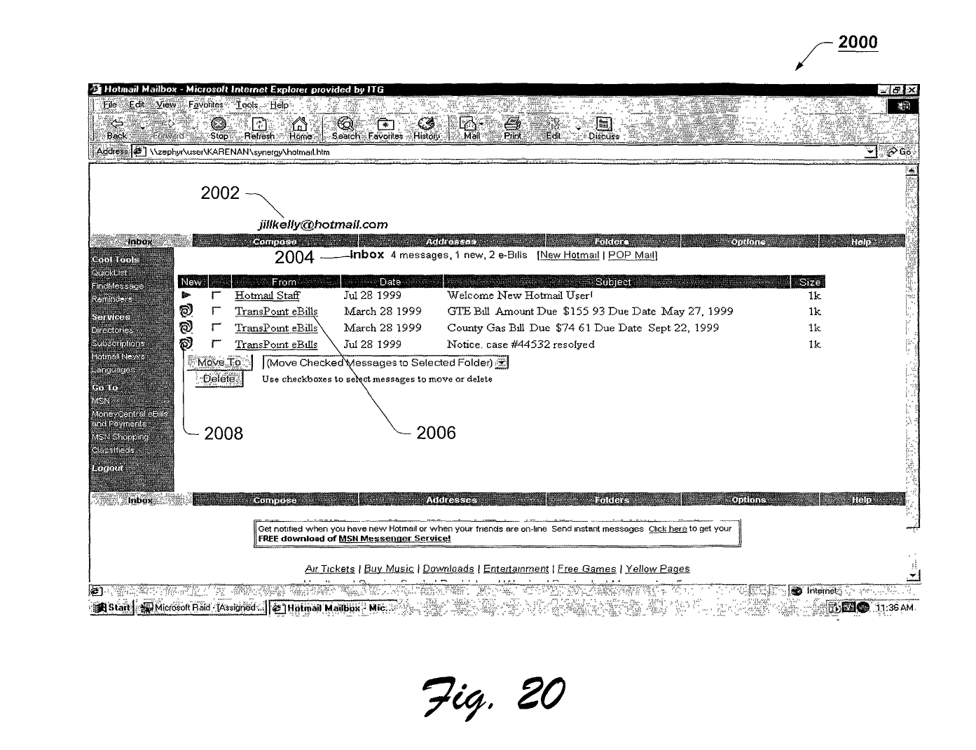

FIG. 20 is a graphical illustration of an alternate user interface through which users may access and utilize the features of financial transaction manager 116, according to an alternate embodiment of the present invention. According to this embodiment, FTM 116 provides a user with an email interface to access and utilize the resources of FTM 116, described above. The user interface 2000 includes a user identifier 2002, header information denoting the particular screen and a summary of screen content 2004, as well as a body 2006 in which more detailed billing information (for example) is displayed. The level of information provided within the detail of body 1906 depends, in large part, on the type of email system used.

If a normal email system is used, relying on the public email network for transmission, selecting an item from the body 2006 will inform the user that a bill has been received from a particular user (business or consumer), and will provide an address to see further detail. If, as according to one implementation, the email system is a web-based email system hosted by a trusted entity, e.g., FSC 102 and/or financial institution, the email client may support a number of innovative Financial MIME sub-types which selectively invoke the innovative functions of FTM 116, described above. In this way, a graphical user interface of an email client operating on a cell phone, for example, can access and utilize the features of the innovative FTM 116.

FIG. 21 is a block diagram of a storage medium having stored thereon a plurality of instructions including instructions to implement the teachings of the present invention, according to yet another embodiment of the present invention. In general, FIG. 21 illustrates a storage medium/device 2100 having stored thereon a plurality of executable instructions 2102 including at least a subset of which that, when executed, implement the financial service center 102 with innovative financial transaction manager 116 of the present invention. When executed by a processor of a host system, the executable instructions implementing FSC 102 with FTM 116 facilitate a plurality of financial transactions among and between any user of the FSC, as well as from a user to a non-user of the FSC. In this regard, execution of the subset of instructions 2102 implementing the FSC 102 facilitate implementation of an innovative ubiquitous financial network 100.

As used herein, storage medium 2000 is intended to represent any of a number of storage devices and/or storage media known to those skilled in the art such as, for example, volatile memory devices, non-volatile memory devices, magnetic storage media, optical storage media, and the like. Similarly, the executable instructions are intended to reflect any of a number of software languages known in the art such as, for example, C++, Visual Basic, Hypertext Markup Language (HTML), Java, eXtensible Markup Language (XML), and the like. Moreover, it is to be appreciated that the storage medium/device 2100 need not be co-located with any host system. That is, storage medium/device 2100 may well reside within a remote server communicatively coupled to and accessible by an executing system. Accordingly, the software implementation of FIG. 21 is to be regarded as illustrative, as alternate storage media and software embodiments are anticipated within the spirit and scope of the present invention.

Although the invention has been described in language specific to structural features and/or methodological steps, it is to be understood that the invention defined in the appended claims is not necessarily limited to the specific features or steps described. Rather, the specific features and steps are disclosed as exemplary forms of implementing the claimed invention.

1. A data network comprising:
a plurality of computing devices, coupled to the network, to facilitate network access by one or more participants; and
a data server, coupled to the data network and responsive to one or more of the plurality of computing devices, the data server including:
a storage medium to store at least one financial account for each of the plurality of participants; and
a financial transaction manager, coupled to the memory device and selectively invoked by a participant, to manage access to and manipulation of financial account assets to effect requested financial transactions with any network participant or non-participant.

2. A data network according to claim 1, wherein the financial account is electronically linked to an account of the participant at a financial institution.

3. A data network according to claim 2, wherein the account of the participant is one of a checking account, a savings account, a line of credit, and a money market account maintained by a banking institution, or a services account associated with another commercial enterprise.

4. A data network according to claim 1, wherein the financial account is one of a checking account, a savings account, a line of credit, and a money market account maintained by a banking institution.

5. A data network according to claim 1, wherein the computing devices is one of a personal computer, a kiosk, a telephone and a set-top box having sufficient resources to enable the participant to access the data server and utilize the financial transaction manager.

6. A data network according to claim 1, further comprising a financial service center having a plurality of data servers including the data server.

7. A data network according to claim 1, wherein the data server is controlled by a financial institution.

8. A data network according to claim 1, wherein the financial transaction manager selectively transfers assets from a first participant's account to a second participant's account in response to a request by the first participant to transfer such assets.

9. A data network according to claim 8, wherein each of the first and second participants are individual consumers.

10. A data network according to claim 8, wherein the first participant does not have a priori knowledge of the second participant's account information, but identifies the second participant from a list of network participants.

11. A data network according to claim 10, wherein the second participant is identified by one or more of a name, an alias, a physical address, a virtual address, or an email address.

12. A data network according to claim 1, wherein the financial transaction manager selectively receives assets for deposit in an account of a participant.

13. A data network according to claim 12, wherein the assets are received from a brokerage at the request of the participant.

14. A data network according to claim 12, wherein the assets are received from an employer as compensation to the participant.

15. A data network according to claim 1, wherein the financial transaction manager prompts a participant for payment authorization in response to a request for payment received from a network service.

16. A data network according to claim 15, wherein the network service is an electronic auction service.

17. A data network according to claim 15, wherein the network service is an electronic retail service.

18. A data network according to claim 15, wherein the financial transaction manager transfers assets from an account specified by the user to an account specified in the request to cover the requested payment, upon authorization of the participant.

19. A data network according to claim 18, wherein the financial transaction manager determines whether to honor the participants payment when the specified account has insufficient assets to cover the requested payment.

20. A data network according to claim 19, wherein the financial transaction manager utilizes a growing trust model to determine whether to honor the payment when the specified account has insufficient assets to cover the requested payment.

21. A data network according to claim 19, wherein the financial transaction manager automatically accesses a line of credit associated with the participant to honor the payment when the specified account has insufficient assets to cover the requested payment.

22. A data network according to claim 21, wherein the financial transaction manager notifies the participant of the insufficient funds and that the line of credit has been accessed to honor the requested payment.

23. A data network according to claim 15, wherein the financial transaction manager issues an instruction to have a check issued and sent to an address specified by the request, upon authorization of the participant.

24. A data network according to claim 23, wherein the issued check includes a uniform resource locator (URL) address of a web page offered by the data server where the recipient can establish an account.

25. A data network according to claim 24, wherein the check includes an offer of free assets, credited to a newly established account created by the recipient of the check.

26. A storage medium having stored thereon a plurality of executable instructions which, when executed, implement a financial transaction manager according to claim 1.

27. A financial service center, selectively accessed by users on a data network using a computing device, the financial service center comprising:
a user interface, through which a user accesses an account associated with the user;
one or more storage devices, to store and maintain account information for each of the users; and
a financial transaction manager, responsive to the user interface and coupled to the one or more storage devices, to manage access to and control assets of user accounts in response to user interaction with the user interface to enable the user to conduct financial transactions with another user or non-user of the financial service center.

28. A financial service center according to claim 27, wherein the user interface is series of instructions issued to a computing device of the user to create a web page at the computing device.

29. A financial service center according to claim 27, wherein the user interface is a series of instructions issued to an email client executing on a computing device of the participant.

30. A financial service center according to claim 27, wherein the financial transaction manager selectively transfers assets from a first user's account to a second user's account in response to a request by the first user to transfer such assets.

31. A financial service center according to claim 27, wherein the financial transaction manager causes a check to be printed and sent to another at the request of a user.

32. A financial service center according to claim 31, wherein the check includes an offer to create an account at the financial service center.

33. A financial service center according to claim 30, wherein each of the first and second users are individual consumers.

34. A financial service center according to claim 30, wherein the first user does not have a priori knowledge of the second user's account information, but identifies the second participant from a list of network participants provided by the financial transaction manager.

35. A financial service center according to claim 30, wherein the second user is identified by one or more of the user's name, alias, or email address.

36. A financial service center according to claim 27, wherein the financial transaction manager selectively receives assets for deposit in an account of a participant.

37. A financial service center according to claim 36, wherein the assets are received from a brokerage at the request of the participant.

38. A financial service center according to claim 36, wherein the assets are received from an employer as compensation to the participant.

39. A financial service center according to claim 27, wherein the financial transaction manager prompts a participant for payment authorization in response to a request for payment received from a network service.

40. A financial service center according to claim 39, wherein the network service is an electronic auction service.

41. A financial service center according to claim 39, wherein the network service is an electronic retail service.

42. A financial service center according to claim 39, wherein the financial transaction manager transfers assets from an account specified by the user to an account specified in the request to cover the requested payment, upon authorization of the participant.

43. A financial service center according to claim 42, wherein the financial transaction manager determines whether to honor the participants payment when the specified account has insufficient assets to cover the requested payment.

44. A financial service center according to claim 42, wherein the financial transaction manager utilizes a growing trust model to determine whether to honor the payment when the specified account has insufficient assets to cover the requested payment.

45. A financial service center according to claim 42, wherein the financial transaction manager automatically accesses a line of credit associated with the participant to honor the payment when the specified account has insufficient assets to cover the requested payment.

46. A financial service center according to claim 15, wherein the financial transaction manager issues an instruction to have a check issued and sent to an address specified by the request, upon authorization of the participant.

47. A financial service center according to claim 23, wherein the issued check includes a uniform resource locator (URL) address of a web page offered by the data server where the recipient can establish an account.

48. A financial service center according to claim 24, wherein the check includes an offer of free assets, credited to a newly established account created by the recipient of the check.

49. A storage medium having stored thereon a plurality of executable instructions which, when executed, implement a financial service center according to claim 27.

50. This invention concerns a system and associated methods for facilitating personal electronic financial transactions.

51. A storage medium having stored thereon a plurality of executable instructions which, when executed, implement the financial transaction manager of claim 1.

52. A method for conducting business comprising:
receiving a request to issue a check to a recipient from a consumer; and
including on the check an offer to receive future funds via an electronic financial account with a pre-printed unique access code for the account.

53. A method for soliciting new users to utilize an electronic financial network, the method comprising:
receiving a request to perform a financial transaction at a data server within a financial data network from a requesting participant;
issuing a physical check drawn from an account on the financial data network associated from an account of the network participant to the transaction recipient, wherein the check includes an offer to utilize an account created within the electronic financial network and associated with the

54. A method for conducting business, the method comprising:
receiving a request for payment from a participant in an electronic financial network; and
soliciting payment via the electronic financial network, providing the
to maintain financial data for each of the plurality of participants to facilitate electronic financial transactions between participants

55. An apparatus comprising:
a storage device having stored thereon a plurality of executable instructions; and
a processor, coupled to the storage device, to execute the instructions and implement a financial transaction manager, wherein the financial transaction manager enables a user to conduct financial transactions with a number of peo
